(19) United States
(12) Patent Application Publication
(10) Pub. No.: US 2015/0248986 A1
(43) Pub. Date: Sep. 3, 2015

(54) THERMAL TRIP DEVICE OF A THERMAL MAGNETIC CIRCUIT BREAKER HAVING A RESISTOR ELEMENT, THERMAL MAGNETIC CIRCUIT BREAKER AND SWITCHING DEVICE FOR INTERRUPTING A CURRENT FLOW AND METHOD FOR PROTECTING AN ELECTRICAL CIRCUIT FROM DAMAGE

(71) Applicant: SIEMENS AKTIENGESELLSCHAFT, Munich (DE)

(72) Inventor: Carlos FLORES SILGUERO, Garcia N.l. (MX)

(21) Appl. No.: 14/559,048

(22) Filed: Dec. 3, 2014

(30) Foreign Application Priority Data
Feb. 28, 2014 (EP) 14157175.2

(51) Int. Cl. H01H 61/04; H01H 61/01

(52) U.S. Cl. CPC H01H 61/04; H01H 61/01

(57) ABSTRACT

A thermal magnetic circuit breaker is disclosed for protecting an electrical circuit from damage by overload, along with a thermal trip device and a switching device of the thermal magnetic circuit breaker and a method for protecting an electrical circuit from damage. In at least one embodiment, an electric conductive bimetal element is arranged with its first end next to a current conductive element for conducting electrical current and with its second end next to a tripping element adapted to trigger an interruption of a current flow. A resistor element is arranged between the bimetal element and the current conductive element in order to redirect the electrical current at least partially via the bimetal element, when an overload occurs.

### PRIORITY STATEMENT

The present application hereby claims priority under 35 U.S.C. §119 to European patent application number EP 14157175.2 filed Feb. 28, 2014, the entire contents of which are hereby incorporated herein by reference.

### FIELD

At least one embodiment of the present invention is generally directed to a thermal trip device of a thermal magnetic circuit breaker, wherein the thermal trip device has at least a bimetal element and a resistor element. At least one embodiment of the present invention is also generally directed to a switching device for interrupting a current flow and having at least a current conductive element, a tripping element, a bimetal element, a resistor element and/or a blade element. Furthermore, on the one hand, at least one embodiment of the present invention is generally directed to a thermal magnetic circuit breaker having a switching device like mentioned above and on the other hand to a method for protecting an electric circuit from damage by overload by way of a thermal trip device of a thermal magnetic circuit breaker.

### BACKGROUND

Essentially, it is known that a thermal magnetic circuit breaker is a manually or automatically operating electrical switch designed to protect an electrical circuit from damage caused by overload or short circuit, for example. Its basic function is the detection of a fault condition and the interruption of current flow. Therefore, the thermal magnetic circuit breaker has for example at least one magnetic trip device in order to prevent the electrical circuit or an electrical device from damage by short circuit and a thermal trip device in order to prevent the electric circuit or an electrical device, like a load, from damage by overload. A short circuit is an abnormal connection between two nodes of the electric circuit intended to be at different voltages. Moreover, especially in reference to a molded-case circuit breaker, short-circuit is an abnormal connection between two separate phases, which are intended to be isolated or insulated from each other. This results in an excessive electric current, named an overcurrent limited only by the Thévenin equivalent resistance of the rest of the network and potentially causes circuit damage, overheating, fire or explosion. An overload is a less extreme condition but a longer-term over-current condition as a short circuit.

The thermal magnetic circuit breaker or breaker, respectively, has different settings or adjustments, respectively, as to where does the client wants the breaker to trip thermally. These settings go for example from 0.8 ln to 1 ln, wherein 0.8 ln means 80% of the nominal current rated on the breaker and 1 ln means 100% of the nominal current rated on the breaker. Therefore, in a 100 Amp breaker, 80% will be 80 Amp.

Basing on a lower thermal adjustment, less electrical current goes through a conductive element like a conductor and results on a lower temperature on a bimetal element of the thermal trip device. Bimetal element is used in thermal magnetic circuit breaker with thermal protection in order to protect the electrical installation by sensing the current, wherein in case of an over-current, the bimetal element deflects enough to activate a breaker mechanism. The temperature profile of the thermal trip device of the thermal magnetic circuit breaker or thermal magnetic trip unit (TMTU) presents low temperature behaviour on the lower thermal adjustment side, which is for example 80% ln and therefore 80% of the nominal current, as mentioned above. Since the movement of the bimetal element is a result of the temperature, such a low temperature is not enough in order to reach deflection and force of the bimetal element, which are necessary to unlatch the breaker mechanism. Essentially, the bimetal element needs a temperature of circa 150° C. in order to reach a sufficient deflection and release the breaker mechanism after an overload fault in the thermal magnetic circuit breaker. Therefore, the deflection of the bimetal element is not enough for doing contact to the breaker mechanism, when a temperature is reached low like for example circa 80° C. In order to control a tripping time delay, a calibration screw to control the distance between the bimetal element and an element that performs the function of releasing the breaker mechanism is adjusted. However, a calibration screw needs a detailed time-consuming calibration from the manufacturer. The tripping time is chosen to meet the requirements of the applicable standard, i.e. UL-489 or IEC-60947. Furthermore, the bimetal element is directly heated by the electrical current passing through it. Because the rated electrical current level is relatively low for low-amperage-rated circuit breakers, a high-reactive bimetal element has to be chosen to accomplish sufficiently deflection to trip the breaker mechanism during an overload.

High-reactive bimetal elements facilitate the calibration process. However, in case of a short-circuit, the high-reactive bimetal element can be damaged due to the excessive thermal stresses because of the high electrical current level. Therefore, low-reactive bimetal elements are used often, wherein in this case, the calibration process is not facilitated anymore. Also it is known that some manufacturers include a parallel current path, which is activated by way of a magnetic circuit or magnetic trip device, respectively, of the thermal magnetic circuit breaker, to deviate at least a part of the electrical current from the bimetal element. However, this approach still needs thermal calibration and is insufficient to achieve high interruptive ratings.

Moreover, thermal magnetic circuit breakers are known, which use a cost-intensive and maintenance-prone electronic device to sense the electrical current, which leads to a price increase.

### SUMMARY

At least one embodiment of the present invention is directed to a thermal magnetic circuit breaker and especially a thermal trip device of a thermal magnetic circuit breaker and more especially a switching device and a method for protecting an electric circuit from damage by overload, by which in an easy and cost-effective manner the contradiction between a low-reactive bimetal element needed to withstand the short circuit current and a high-reactive bimetal element needed to facilitate the thermal tripping in case of an overload for a thermal magnetic circuit breaker below 100 A rated current is resolved.

A thermal trip device, a switching device, a thermal magnetic circuit breaker and a method for protecting an electric circuit from damage by overload are disclosed. Further features and details of the invention are subject of the sub claims and/or emerge from the description and the figures. Features and details discussed with respect to the thermal trip device can also be applied to the switching device, the thermal magnetic circuit breaker and/or the method for protecting an electric circuit from damage and vice versa.

According to a first aspect of at least one embodiment of the invention, the thermal trip device of a thermal magnetic circuit breaker for protecting an electrical circuit from damage by overload has at least an electric conductive bimetal element in order to be arranged with its first end next to a current conductive element for conducting electrical current and in order to be arranged with its second end next to a tripping element adapted to trigger an interruption of a current flow. Furthermore, the thermal trip device has a resistor element arranged at the bimetal element between the bimetal element and the current conductive element in order to redirect the electrical current at least partially via the bimetal element, when an overload occurs.

Furthermore, according to a second aspect of at least one embodiment of the invention, a thermal magnetic circuit breaker for protecting an electrical circuit from damage caused by overload or short circuit is claimed. The thermal magnetic circuit breaker has at least one switching device according to the second aspect of at least one embodiment of the invention, and therefore a switching device like mentioned above. Thus, the thermal magnetic circuit breaker has a thermal trip device like mentioned above according to the first aspect of at least one embodiment of the invention. Advantageously, the thermal magnetic circuit breaker has a magnetic system and especially a translational magnetic trip device in order to interrupt a current flow during a trip event, as a short circuit occurs in order to prevent the circuit from damage.

Furthermore, a method for protecting an electric circuit from damage by overload by way of a thermal trip device of a thermal magnet circuit breaker is disclosed. The method, in at least one embodiment, has at least the following steps:

during an overload occurs the resistance of the resistor is reduced in order to redirect electrical current at least partially via an electric conductive bimetal element arranged with its first end next to a current conductive element and with its second end next to a moveable blade arranged to interrupt a current flow, wherein basing on the heating up of the bimetal element, a mechanical displacement of at least one area of the bimetal element is obtained in order to move a tripping element to trigger the opening of the blade element in order to interrupt the current flow.

### BRIEF DESCRIPTION OF THE DRAWINGS

Embodiments of a thermal trip device, a magnetic trip device and a switching device of a thermal magnetic circuit breaker are explained in more detail with reference to the accompanying drawings. The drawings show schematically in:

FIG. 1: an electrical connection diagram of an embodiment of a switching device,

FIG. 2: a side view of an embodiment of a switching device having an embodiment of a thermal trip device,

FIG. 3: a temperature-resistivity relationship diagram of an embodiment of the resistor element,

FIG. 4: a time-temperature relationship diagram of an embodiment of the resistor element, and

FIG. 5: a perspective view of an embodiment of a magnetic trip device of a thermal magnetic circuit breaker arranged on a current conductive element.

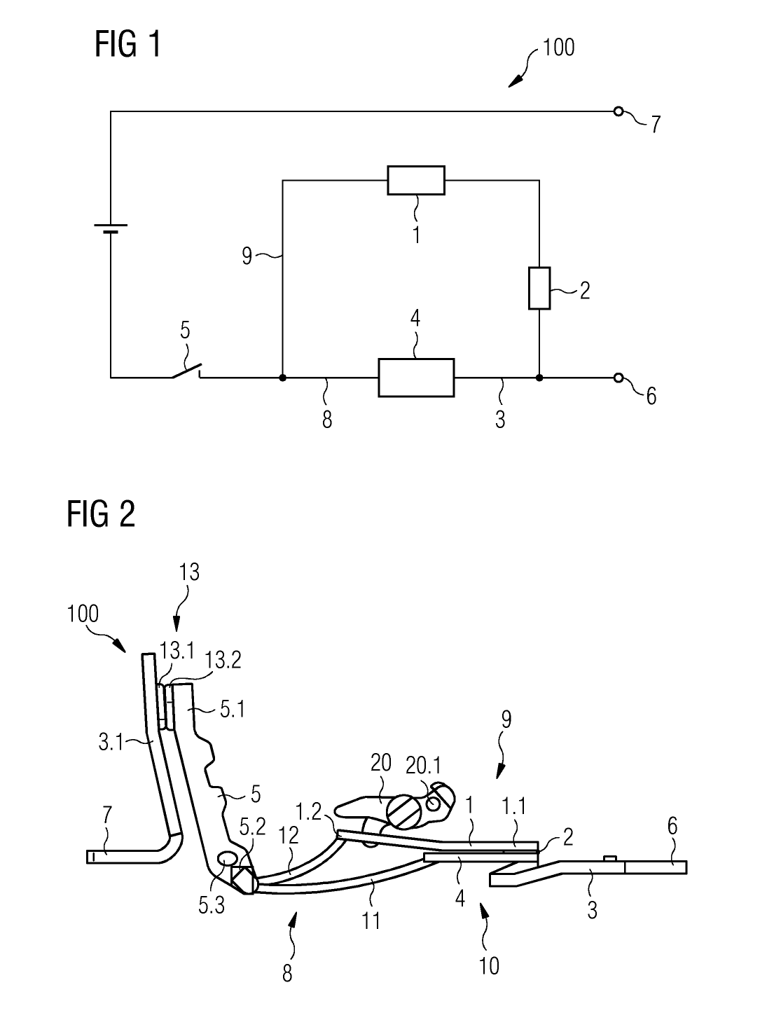

Elements having the same function and mode of action are provided in FIGS. 1 to 5 with the same reference signs.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

According to a first aspect of at least one embodiment of the invention, the thermal trip device of a thermal magnetic circuit breaker for protecting an electrical circuit from damage by overload has at least an electric conductive bimetal element in order to be arranged with its first end next to a current conductive element for conducting electrical current and in order to be arranged with its second end next to a tripping element adapted to trigger an interruption of a current flow. Furthermore, the thermal trip device has a resistor element arranged at the bimetal element between the bimetal element and the current conductive element in order to redirect the electrical current at least partially via the bimetal element, when an overload occurs.

Advantageously, the thermal trip device is a part of the thermal magnetic circuit breaker mentioned above and has at least a bimetal element, which is composed of at least two separate metals joined together. The bimetal element consists of two layers of different metals, for example, wherein bimetal elements having three or four separate metals or layers, respectively, are referred to as trimetal or tetrametal. Therefore, the bimetal element of the present invention is also able to have three, four or more than four separate metals or layer, respectively.

The electrical current flowing through the conductive element emits heat, by which the bimetal element or trimetal element or tetrametal element, and so on, is heated, wherein due to this heat, a movement and especially a deflection of the bimetal element is triggered. That means, based on the nature of the bimetal element, it converts the heat or temperature, respectively, into mechanical displacement generating certain amount of force. Thus, the amount of heat restricts the amount of force that will generate. Increasing the temperature generally of the current path and especially in the area of the conductive element of the thermal trip device results for example in overheating of lugs arranged at least nearly the conductive element above especial requirement specifications and therefore above for example a temperature of circa 50° C. Thus, an increasing of the temperature of the current conductive element in order to optimize the movement of the bimetal element in order to interrupt the electrical current flow of the current circuit for protecting the circuit from overload, leads to damage loads or comparable products. In the context of the present invention the electrical circuits includes also at least one load like an electrical device.

Therefore, the directly heating of the bimetal element is advantageously.

The bimetal element has a first end, also named lower end and a second end, also named upper end. Advantageously, the first end is at least partially arranged next to a part of a current conductive element, which is for example a current conductive line, wherein the second end is arranged next to a tripping element or tripping slide, respectively, arranged to interact with a breaker mechanism or latch mechanism, respectively, in order to interrupt a current flow. The current conductive element is a part of the current path and able to conduct electrical current from an energy source to a load. Heat or thermal energy, respectively, emitted by the electrical current flowing through the current conductive element is able to migrate from the current conductive element via the first end of the bimetal element to the bimetal element in such a way that the bimetal element is heated at least indirectly. The heat causes the bimetal element to deflect, wherein the bimetal element moves in direction to the tripping element in order to contact and to unlatch the tripping element. If the deflection is insufficient, because of a low reached temperature like mentioned above, the second end of the bimetal element is not able to contact or to unlatch the tripping element.

In order to overcome these disadvantages, a resistor element is arranged between the bimetal element and the current conductive element and especially between the first end of the bimetal element and a surface of the current conductive element. Advantageously, the resistor element is arranged between the bimetal element and a heater element, which is either a component of the current conductive element or a separate component contacting the current conductive element. The heater element is able to limit the short-circuit current and to maintain the temperature profile of the breaker within the temperature rise specification, advantageously. For this limiting, the cross-sectional area and length of the heater must be chosen. It is conceivable that the first end and/or second end of the bimetal element are areas of the bimetal element extending from the ends of the longest side of the bimetal element in direction to its middle or centre, respectively. Thus, both, the first end and the second end can have a half-length of the overall length or more or less of the bimetal element.

According to at least one embodiment of the present invention, the resistor element is a passive two-terminal electrical component that implements electrical resistance. The current through a resistor is in direct proportion to the voltage across the resistors terminals.

It is conceivable that in case of an overload, the resistor will switch to a conductive state and the electrical current will flow through the bimetal element and cause it to bend due to the joule heating effect. Based on this heating, the bimetal element bending or deflecting against a tripping element unlatches the tripping element. Advantageously, the tripping element is a tripping slide or tripping lever rotatable around its pivot axis in order to activate a breaker mechanism or unlatch mechanism, respectively, of the thermal magnetic circuit breaker for interrupting a current flow.

Advantageously, in case of a short-circuit, the resistor element does not change to a conductive state because for example the time period is too short compared to the time constant of the resistor. Therefore, an electrical current cannot flow through the bimetal element, so that the bimetal element is prevented from damage.

Advantageously, by way of the thermal trip device, the use of a high-reactive bimetal element is allowed, because the bimetal element does not need a calibration adjustment, because it will always reach the tripping device in case of an overload.

It is conceivable that the resistor element is a thermistor and especially a negative temperature coefficient thermistor. According to at least one embodiment of the present invention, a thermistor is a type of resistor, whose resistance varies significantly with temperature. Thermistors are made for example of semiconductor material that has been sintered in order to display large changes in resistance in proportion to small changes in temperature. Negative temperature coefficient thermistor (NTC-thermistor) is a non-linear resistor, which alter its resistance characteristics with temperature. Therefore, the resistance of the NTC-thermistor will decrease as the temperature increases. That means that during a normal operation of the breaker at rated current, the heat produced by the current conductive element or the heater element is not enough to commute the state of the thermistor, which is in a non-conductive state at low temperature. Therefore, on the one hand, the electrical current cannot flow through the bimetal element.

Advantageously, the thermistor protects the bimetal element against damage caused by a short-circuit. On the other hand, the thermistor enables the conducting of electrical current along the bimetal element and therefore a sufficient heating of the bimetal element by way of the electrical current during an overload. An overload caused a slow heating of the heater element or the current conductive element, so that the resistance of the thermistor is reduced.

In order to enable a current path to conduct electrical current via the bimetal element during an overload occurs, it is conceivable that the second end of the bimetal element can be arranged at a first flexible connector element arranged at a connection end of a moveable blade element for interrupting an electrical current flow. The connector element is for example a connector line as a current line for conducting electrical current from one component to another. Advantageously, the connector element has a flexible or elastic material, respectively, which is stretchable and moveable at least within predefined ranges. Therefore, the bending or deflecting, respectively, of the bimetal element in direction to the tripping element does not cause a damage of the current path extending from the current conductive element, via the resistor and the bimetal element to the connector element and via the connector element to a load and especially to an energy sink, for example.

It is also conceivable that the resistor element can be arranged at a heater element for heating the resistor element because of the electrical current flowing through the current conductive element. Advantageously, the heater element made like mentioned above serves inter alia as heat conductive element for conducting heat or thermal energy, respectively, from a current conductive element in direction to the bimetal element.

Furthermore, in an embodiment, a switching device for interrupting an electrical current flow during an overload is claimed. The switching device has at least a current conductive element for conducting electrical current, a tripping element adapted to interact with a moveable blade element, an electric conductive bimetal element in order to be arranged with its first end next to a current conductive element and in order to be arranged with its second end next to a tripping element, a resistor element arranged between the bimetal element and the current conductive element in order to redirect the electrical current at least partially via the bimetal element, and/or a blade element for interrupting the current flow. The resistor element stays in electrical contact to the bimetal element and the current conductive element. It is conceivable that the tripping element is arranged at a kicker element, which is able to hitch a mechanism trip bar for unlatching a breaker mechanism in order to interrupt a current flow or a current path, respectively. It is possible that the kicker element and/or the mechanism trip bar are components of the switching device. Advantageously, the bimetal element of the switching device is heated directly, when the electrical current is conducted through the bimetal element and therefore through a second or parallel current path with respect to the first or normal current path. In the context of at least one embodiment of the invention, the first or normal current path conducts the electrical current during a normal operation of the thermal magnetic circuit breaker at rated current, wherein no trip event as an overload or a short-circuit occurs. Basing on the heating up of the bimetal element, the latter is deflected or bended, respectively, in direction to the tripping element. When the bimetal element gets the temperature desired of the tripping for example circa 80° C., the bimetal element will contact and unlatch the tripping element. With regard to the features of the current conductive element, the tripping element, the resistor element and the bimetal element, herewith it is referred to the explanations mentioned above.

The blade element is a lever element, for example, and is arranged at least next to a load terminal of the electrical connection or electrical circuit, respectively. Advantageously, the blade element has two ends, namely a contact end and a connection end. These ends are areas or zones, respectively, extending from distal ends of the blade element in direction to its centre and having same or different lengths.

Furthermore, it is conceivable that the blade element has at least a moveable contact fixed on a contact end of the blade element in order to enable a current flow or to interrupt the current flow. The contact or contact element, respectively, is a conductive electrical circuit component for conducting electrical current from the blade element to the load terminal mentioned above. Therefore, the contact is also named electrical contact.

According to at least one embodiment of the present invention, the contact is composed of at least one piece and preferably two pieces of electrically conductive metal that pass electrical current. The contact is arranged at one side and especially at the contact side or contact end, respectively, of the blade element. Therefore, the contact is arranged between the blade element and a further conductive element like a conductive line and especially a load terminal. The contact is moveable when the blade element is moved due to a movement of the tripping element, for example.

Advantageously, the blade element is able to rotate about its pivot axis in order to move the contact end. Therefore, the contact is moved in direction away from the load terminal, when an overload occurs or in the opposite direction and thus in direction to the load terminal during a normal operation of the thermal magnetic circuit breaker. The movement of the blade element bases on the movement of the tripping element unlatched by the deflected bimetal element during a trip event as an overload occurs. Advantageously, only one piece of the two pieces of the contact is arranged at the blade element and therefore moveable, during the other piece is arranged at the load terminal or the further conductive element, respectively. Therefore, the other piece is not moveable with the blade element. Thus, the contact or contact element, respectively, is moveable at least partly.

It is conceivable that the tripping element is coupled to at least one and especially two or more biasing devices or components, respectively, interposed between the blade element and the tripping element in order to pivot the blade element between respective positions. One position is for example the current conductive position (initial position) and the other position is for example the current flow breaking position. During the current conductive position, the contact contacts the load terminal or the first piece of the contact element contacts the second piece of the contact element in order to enable an electrical current flow. During a current flow breaking event, the blade element pivots about its pivot axis in such a way that a contact between the contact element and the load terminal or a contact between the first piece and the second piece of the contact element is prevented.

Moreover, it is conceivable that a connection end of the blade element is arranged at a first flexible connector element extending between the blade element and the bimetal element and a second flexible connector element extending between the blade element and the current conductive element or the heater element in order to conduct an electrical current. The first connector element and/or the second connector element are preferably connector lines for conducting electrical current and are components of the switching device, advantageously. Both connector elements have at least partly a flexible material stretchable along a predefined length. Thus, a damage of the conductive path and therefore of the first conductive path and the second conductive path is prevented, when a trip event occurs, the bimetal element deflects and the blade element pivots. As housing material of the connector elements for example a polyvinylchloride material, a polyurethane material and/or a material of thermoplastic elastomers is used. Advantageously, the heater element mentioned above is arranged between the current conductive element and the resistor in order to conduct a heat or thermal energy, respectively, generated by way of the electrical current flowing through the current conductive element from the heater element to the resistor.

Advantageously, the switching device has a thermal trip device according to one embodiment. That means that the switching device has a thermal trip device like mentioned above according to the first aspect of at least one embodiment of the invention.

The switching device mentioned above also has all advantages mentioned above concerning the thermal trip device.

Furthermore, according to a second aspect of at least one embodiment of the invention, a thermal magnetic circuit breaker for protecting an electrical circuit from damage caused by overload or short circuit is claimed. The thermal magnetic circuit breaker has at least one switching device according to the second aspect of at least one embodiment of the invention, and therefore a switching device like mentioned above. Thus, the thermal magnetic circuit breaker has a thermal trip device like mentioned above according to the first aspect of at least one embodiment of the invention. Advantageously, the thermal magnetic circuit breaker has a magnetic system and especially a translational magnetic trip device in order to interrupt a current flow during a trip event, as a short circuit occurs in order to prevent the circuit from damage.

It is conceivable that the magnetic trip device of the thermal magnetic circuit breaker has an armature element reacting to a magnetic field resulting from current flowing through a solenoid element. Advantageously, the magnetic trip device has at least an armature element moveable arranged with respect to a yoke or especially to a current conductive element conducting electrical energy or current, respectively. The armature element or armature, respectively, is a magnetic element and especially a pole piece having at least partially an iron material and reacting to a magnetic field created by the yoke during a trip moment. In order to realize a guided movement of the armature element towards the yoke at least during a trip event like a short circuit, the armature element is arranged on an armature locator. The armature locator can be connected with a tripping element, which is able to interrupt a current flow of the current circuit, when the tripping element is moved due to a movement of the armature locator in conjunction with the armature element towards the yoke because of a magnetic force.

The thermal magnetic circuit breaker mentioned above also has all advantages mentioned above concerning the thermal trip device and/or the switching device.

Furthermore, a method for protecting an electric circuit from damage by overload by way of a thermal trip device of a thermal magnet circuit breaker is disclosed. The method, in at least one embodiment, has at least the following steps:

during an overload occurs the resistance of the resistor is reduced in order to redirect electrical current at least partially via an electric conductive bimetal element arranged with its first end next to a current conductive element and with its second end next to a moveable blade arranged to interrupt a current flow, wherein basing on the heating up of the bimetal element, a mechanical displacement of at least one area of the bimetal element is obtained in order to move a tripping element to trigger the opening of the blade element in order to interrupt the current flow.

It is conceivable that the resistor element and especially the thermistor is arranged at a heater element arranged at the current conductive element, wherein the heater element is used to transmit heat or thermal energy, respectively, from the current conductive line to the resistor element in order to heat the latter. Due to the heating of the resistor, its resistance is reduced, wherein an electrical currents flows from the current conductive line to the bimetal element. Based on the electrical current flowing through the bimetal element, it heats up and deflects in direction to the tripping element. When the bimetal element and especially a second end of the bimetal element contacts the tripping element, the latter is unlatched and moved in such a way that components of a switching device as a kicker, for example, are unlatched too. A series of reaction and movement of different components of the switching device mentioned above is triggered in order to interrupt the current flow. Therefore, when the blade element is moved and the contact of the contact element arranged at the blade element is interrupted the current path of the electrical current is interrupted, too.

Advantageously, a thermal trip device according to the first aspect of at least one embodiment of the invention, is used and has therefore a shape and/or function like mentioned above.

The method mentioned above also has all advantages mentioned above concerning the thermal trip device and/or the switching device and/or the thermal magnetic circuit breaker.

Advantageously, at least one embodiment of the present invention resolves the contradiction between a low-reactive bimetal element needed to withstand the short circuit current and a high-reactive bimetal element needed to facilitate the thermal tripping in case of an overload in case of a thermal magnetic circuit breaker below 100 A rated current and allows the use of a bimetal element reactive enough, so that a calibration adjustment as a calibration screw is not needed, wherein additionally at the same time the bimetal element is protected during a short circuit.

In FIG. 1, an electrical connection diagram of an embodiment of a switching device 100 is shown. A current conductive element 3 as a current conductive line extends from a line terminal 6 and especially an electrical current source 6 to a load terminal 7 and especially an electrical current sink 7. Advantageously, the current conductive element 3 establishes at least two current paths, namely the first current path 8 and the second current path 9. The second current path 9 is a parallel current path with respect to the first current path 8. The first current path 8 extends from the current source 6 to the current sink 7 and connects a heater element 4 and a blade element 5. Along the first current path 8, an electrical current flows, when no trip event occurs. When a trip event as an overload occurs, the electrical current is redirected at least partly via the second current path 9. The second current path 9 extends from the current source 6 to the current sink 7 and connects a resistor element 2 with a bimetal element 1 and a blade element 5. A redirection of the electrical current from the first current path 8 to the second current path 9 is enabled, when the resistance of the resistor element 2 is sufficiently reduced by way of the thermal energy emitted by the electrical current.

In FIG. 1, an interrupted first 8 and second current path 9 is shown. Herewith, the blade element 5, which is for example a blade switch or a switch element, respectively, is open. The opening of the blade element 5 is caused for example by a movement of a not shown tripping element unlatched by the deflected bimetal element 1. If the blade element 5 is in opened position, contacts or contact parts, respectively, of the blade element 5 do not contact each other, wherein for example one contact part is preferably fixed with the blade element 5 and the other part of the contact is fixed with the current conductive element 3.

In FIG. 2, a side view of an embodiment of a switching device 100 having an embodiment of a thermal trip device 10 is shown. Thus, the thermal trip device 10 is a component of the switching device 100, advantageously. The line terminal 6 or electrical current source 6, respectively, is arranged at a current conductive element 3, which contacts a heater element 4. It is conceivable that the heater element 4 is a component of the current conductive element 3 or a separate component. The heater element 4 or the current conductive element 3, respectively, contacts a resistor element 2, which is preferably a thermistor and more preferably a negative temperature coefficient thermistor (NTS-thermistor).

The resistor element 2 is arranged between the heater element 4 or the current conductive element 3, respectively, and the bimetal element 1. The bimetal element 1 has two ends, namely a first end 1.1 connected to the resistor element 2 and a second end 1.2 connected to a first connector element 11. At the area of the second end 1.2 of the bimetal element 1, a tripping element 20 is arranged to the bimetal element 1 in such a way that a deflection of the bimetal element 1 causes the tripping element 20 to move and especially to pivot around its pivot axis 20.1. Therefore, when a trip event as an overload occurs the bimetal element 1 deflects or bends, respectively, in direction to the tripping element 20 and contacts and pushes the tripping element 20, wherein the tripping element 20 is pivoted in clockwise direction. During the deflection of the bimetal element 1, the first connector element 11 arranged between the bimetal element 1 and the blade element 5 is stretched. Thanks to a flexible material of the first connector element 11, its damage is prevented.

The blade element 5 has a connection end 5.2 and a contact end 5.1. The connection end 5.2 is arranged with the first connector element 11 mentioned above and a second flexible connector element 12 extending between the blade element 5 and the heater element 4 or the current conductive element 3, respectively. The second connector element 12 has at least partly a flexible material, too. Therefore, during a movement of the blade element 5 around its pivot axis 5.3 in case of a trip event occurs the second connector element 12 and also the first connector element 11 are stretchable within at least a predefined range.

At the contact end 5.1 of the blade element 5, a contact 13 or contact element 13, respectively, is arranged. According to FIG. 2, the contact 13 has two parts or pieces, respectively, the first part 13.1 arranged directly at the blade element 5 and a second part 13.2 arranged directly at a further current conductive element 3.1. The further current conductive element 3.1 is the current conductive element 3 arranged at the current source 6 and interrupted by the components mentioned above as for example the blade element 5, the second connector element 12, the heater 4 and so on. In addition, it is conceivable that the further current conductive element 3.1 formed for example as a current line is a second current conductive element 3.1 for conducting electrical current. The further current conductive element 3.1 is arranged with the load terminal 7 or the electrical current sink 7, respectively. The contact 13 or contact element, respectively, is closed, when both parts 13.1 and 13.2 contact each other, wherein the blade element 5 is positioned in an initial position. Like shown in FIG. 2, when the blade element 5 is moved from its initial position to an interrupting position, like shown in FIG. 1 for example, the first part 13.1 of the contact 13 is not able to contact the second part 13.2 of the contact 13 anymore. Advantageously, the blade element 5 pivots around its pivot axis 5.3 in clockwise direction, when a trip event as an overload occurs. Due to this movement of the blade element 5, the first connector element 11 and the second connector element 12 are stretched.

During an overload occurs electrical current flows along the second current path 9 as long as the contact between the first part 13.1 and the second part 13.2 of the contact element 13 will be interrupted due to the movement of the blade element 5. During a normal operation of the breaker, the resistance of the resistor is high enough to prevent a conducting of electrical current from the current conductive element 3 through the bimetal element 1 and the first connector element 11 to the blade element 5 and the load terminal 7.

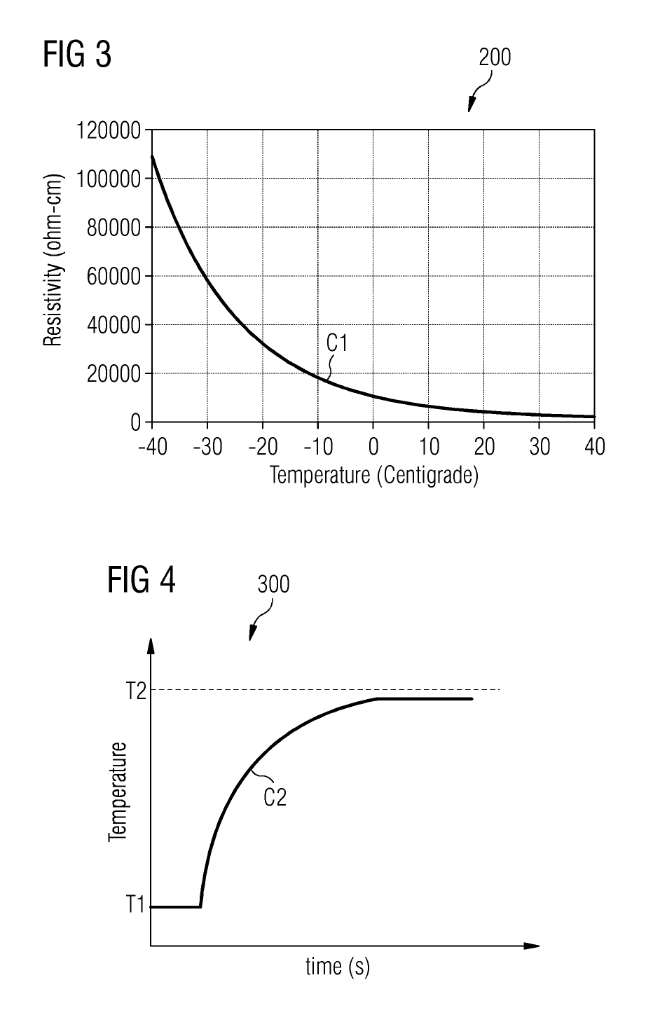

In FIG. 3, a temperature-resistivity relationship diagram 20 of an embodiment of the resistor element 2 and especially a thermistor 2 and more especially a NTC-thermistor is shown. As represented with temperature-resistivity relationship curve C1 (TR-Curve) during a normal operation of the thermal magnetic circuit breaker at rated current, the heat or thermal energy produced by the heater element 4 (cf. FIG. 2) or the current conductive element 3 (cf. FIG. 2), respectively, is not enough to commute the state of the resistor element 2 (cf. FIG. 2), which is in a non-conductive state at low temperatures. Therefore, a flowing of the electrical current through the bimetal element 1 (cf. FIG. 2) is prevented.

In case of an overload more electrical current flows in the same time through the current conductive element 3 (cf. FIG. 2), wherein the current conductive element 3 (cf. FIG. 2) and therefore the heater element 4 (cf. FIG. 2) is heated. This heat causes the resistor element 2 (cf. FIG. 2) to reduce its resistance. Therefore, the resistor element 2 (cf. FIG. 2) will switch to a conductive state and electrical current will flow through the bimetal element 1 (cf. FIG. 2).

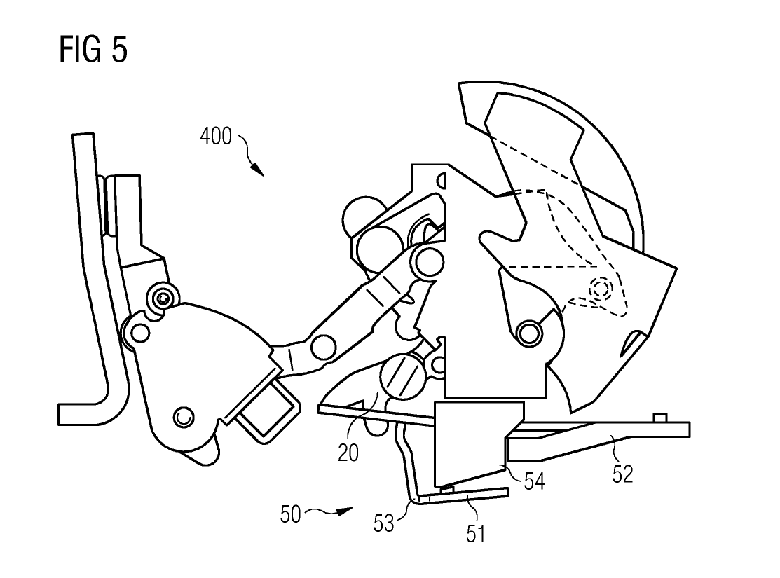

In FIG. 4, a time-temperature relationship diagram 300 of an embodiment of the resistor element 2 (cf. FIG. 2) is show. The time-temperature relationship curve C2 (TT-curve) or time constant curve C2 extending between a first temperature T1 and a second temperature T2 is chosen together with the TR-curve C1 or heat-resistivity curve C1, respectively, shown in FIG. 3, to meet the desired trip time delay of the thermal magnetic circuit breaker.

As shown in FIG. 4, the resistor element 2 (cf. FIG. 2) does not change to a conductive state when a short-circuit occurs, because the time period is too short compared to the time constant of the resistor 2. Therefore, the electrical current does not flow through the bimetal element 1 (cf. FIG. 2) to prevent the latter from being damaged.

Advantageously, the using of a high-reactive bimetal element, which does not need calibration adjustment because it will reach the tripping element in case of overload, is allowed. Therefore, a thermal magnetic circuit breaker that does not need thermal calibration adjustment is easier to produce and the production cycle time is shorten.

In FIG. 5, a perspective view of an embodiment of a magnetic trip device 50 arranged in a thermal-magnetic trip unit (TMTU) 400 is shown. The thermal-magnetic trip unit 400 has at least a thermal trip device 10 and a magnetic trip device 50, both arranged at least partially at the switching device 100. A current conductive element 52 passing through the magnetic yoke 54 caused the yoke 54 to generate a magnetic field. By way of the magnetic field a armature element 51 arranged at least near the yoke 54 is moved in direction to the yoke 54, when a trip event, like an overload is occurred.

Based on the movement of the armature element 51 in direction to the yoke 54 during a trip event, the armature element 51 rotates in a counter clockwise direction around its pivot point 53. Based on this movement, the tripping element 20 is pushed to its final position, where the energy storage is released.

At least one embodiment of the present invention enables the use of a heater element to limit the short circuit electrical current, and in conjunction with the resistor or preferably the NTC-thermistor, allows to increase the interruptive capacity of the circuit breaker, because the bimetal element does not get damaged anymore.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### REFERENCE LIST

1 bimetal element
1.1 first end of the bimetal element
1.2 second end of the bimetal element
2 resistor element/thermistor
3 current conductive element
3.1 further current conductive element
4 heater element
5 blade element
5.1 contact end of the blade element
5.2 connection end of the blade element
5.3 pivot axis of the blade element
6 line terminal/electrical current source
7 load terminal/electrical current sink
8 first current path
9 second current path
10 thermal trip device
11 first connector element
12 second connector element
13 contact/contact element
13.1 first part of the contact
13.2 second part of the contact
20 tripping element
20.1 pivot axis of the tripping element
30 pin
40 adjustment bar
41 protrusion of the adjustment bar
41.1 inclined area/surface of the protrusion
50 magnetic trip device
51 armature element
52 current conductive element
53 pivot point
54 yoke
100 switching device
200 temperature-resistivity relationship diagram
300 time-temperature relationship diagram
400 thermal-magnetic trip unit
C1 temperature-resistivity relationship curve/heat-resistivity curve
C2 time-temperature relationship curve/time-constant curve
H horizontal direction
T1 first temperature
T2 second temperature
V vertical direction

What is claimed is:

1. Thermal trip device of a thermal magnetic circuit breaker for protecting an electrical circuit from damage by overload, the thermal trip device comprising:
an electric conductive bimetal element, arranged with a first end of the electric conductive bimetal element next to a current conductive element, for conducting electrical current, and arranged with a second end of the electric conductive bimetal element next to a tripping element adapted to trigger an interruption of a current flow; and
a resistor element, arranged at the electric conductive bimetal element between the electric conductive bimetal element and the current conductive element, to redirect the electrical current at least partially via the electric conductive bimetal element, when an overload occurs.

2. Thermal trip device of claim 1, wherein the resistor element is a thermistor.

3. Thermal trip device of claim 1, wherein, in order to enable a current path, the second end of the electric conductive bimetal element is arrangeable at a first flexible connector element, arranged at a connection end of a moveable blade element, for interrupting an electrical current flow.

4. Thermal trip device of claim 1, wherein the resistor element is arrangeable at a heater element, for heating the resistor element because of the electrical current flowing through the current conductive element.

5. Switching device for interrupting an electrical current flow during an overload, the switching device comprising:
a current conductive element for conducting electrical current;
a tripping element, adapted to interact with a moveable blade element;
an electric conductive bimetal element, arranged with a first end of the electric conductive bimetal element next to a current conductive element and arranged with a second end of the electric conductive bimetal element next to a tripping element; and
a resistor element, arranged between the bimetal element and the current conductive element, to redirect the electrical current at least partially, via at least one of the bimetal element and a blade element, for interrupting the current flow.

6. Switching device of claim 5, wherein the blade element includes at least a moveable contact, fixed on a contact end of the blade element, to enable a current flow or to interrupt the current flow.

7. Switching device of claim 5, wherein a connection end of the blade element is arranged at a first flexible connector element extending between the blade element and the electric conductive bimetal element, and a second flexible connector element extending between the blade element and the current conductive element, to conduct an electric current.

8. Thermal magnetic circuit breaker for protecting an electrical circuit from damage caused by overload or short circuit, comprising:
at least one of the switching device of claim 5.

9. Method for protecting an electric circuit from damage by overload by way of a thermal trip device of a thermal magnet circuit breaker, the method comprising:
reducing, during an overload occurrence, the resistance of a resistor to redirect electrical current, at least partially, via an electric conductive bimetal element, arranged with a first end of the electric conductive bimetal element next to a current conductive element and a second end of the electric conductive bimetal element next to a moveable blade element, arranged to interrupt a current flow; and
obtaining, based on heating up of the electric conductive bimetal element, a mechanical displacement of at least one area of the electric conductive bimetal element to move a tripping element to trigger opening of the blade element to interrupt the current flow.

10. Method for protecting an electric circuit from damage by overload via the thermal trip device of a thermal magnet circuit breaker of claim 1, the method comprising:
reducing, during an overload occurrence, the resistance of a resistor to redirect electrical current, at least partially, via an electric conductive bimetal element, arranged with a first end of the electric conductive bimetal element next to a current conductive element and a second end of the electric conductive bimetal element next to a moveable blade element, arranged to interrupt a current flow; and
obtaining, based on heating up of the electric conductive bimetal element, a mechanical displacement of at least one area of the electric conductive bimetal element to move a tripping element to trigger opening of the blade element to interrupt the current flow.

11. Thermal trip device of claim 2, wherein the resistor element is a negative temperature coefficient thermistor.

12. Thermal trip device of claim 2, wherein, in order to enable a current path, the second end of the electric conductive bimetal element is arrangeable at a first flexible connector element, arranged at a connection end of a moveable blade element, for interrupting an electrical current flow.

13. Thermal trip device of claim 2, wherein the resistor element is arrangeable at a heater element, for heating the resistor element because of the electrical current flowing through the current conductive element.

14. Thermal trip device of claim 3, wherein the resistor element is arrangeable at a heater element, for heating the resistor element because of the electrical current flowing through the current conductive element.

15. Switching device of claim 6, wherein a connection end of the blade element is arranged at a first flexible connector element extending between the blade element and the electric conductive bimetal element, and a second flexible connector element extending between the blade element and the current conductive element, to conduct an electric current.

16. Thermal magnetic circuit breaker for protecting an electrical circuit from damage caused by overload or short circuit, comprising:
at least one of the switching device of claim 6.

17. Thermal magnetic circuit breaker for protecting an electrical circuit from damage caused by overload or short circuit, comprising:
at least one of the switching device of claim 7.
